(19) United States
(12) Patent Application Publication
(10) Pub. No.: US 2025/0362920 A1
(43) Pub. Date: Nov. 27, 2025

(54) PROCESSING APPARATUS, METHOD FOR PROCESSING INSTRUCTIONS, AND ELECTRONIC DEVICE

(71) Applicants: Xian ESWIN Computing Technology Co., Ltd., Xi'an (CN); Beijing ESWIN Computing Technology Co., Ltd., Beijing (CN)

(72) Inventors: Xiansheng YIN, Beijing (CN); Kunpeng ZHAO, Beijing (CN); Chao WANG, Beijing (CN)

(21) Appl. No.: 18/938,844

(22) Filed: Nov. 6, 2024

(30) Foreign Application Priority Data
May 22, 2024 (CN) 202410642505.1

(51) Int. Cl. G06F 9/38

(52) U.S. Cl. CPC G06F 9/3836; G06F 9/3838; G06F 9/3867

(57) ABSTRACT

The present application provides a processing apparatus. The processing apparatus includes a processing unit and a multi-stage pipelining. The processing unit is configured to execute instructions of the multi-stage pipelining; a first-stage pipelining in the multi-stage pipelining is configured to acquire a first instruction and transmit the first instruction and a first operand to the processing unit in response to acquiring the first operand of the first instruction, and the first-stage pipelining is any one stage of pipelining in the multi-stage pipelining; and the processing unit is configured to acquire a first processing result by receiving and processing the first instruction and the first operand.

The present disclosure claims priority to Chinese Patent Application No. 202410642505.1 filed on May 22, 2024, and entitled “PROCESSING APPARATUS, METHOD FOR PROCESSING INSTRUCTIONS, AND ELECTRONIC DEVICE”, the content of which is incorporated herein by reference in its entirety.

### TECHNICAL FIELD

The embodiments of the present disclosure relate to the technical field of computers, in particular, to a processing apparatus, a method for processing instructions, and an electronic device.

### BACKGROUND

In the technical field of computers, a processing apparatus is an important component of the computer. Processing apparatuses with different architectures process the instructions by adopting different methods for processing instructions to obtain processing results, so as to support the computer to realize various functions based on the processing results.

### SUMMARY

The present disclosure provides a processing apparatus, a method for processing instructions, and an electronic device. The technical solutions are as follows.

Some embodiments of the present disclosure provide a processing apparatus. The processing apparatus includes a processing unit and a multi-stage pipelining. The processing unit is configured to execute instructions of the multi-stage pipelining; a first-stage pipelining in the multi-stage pipelining is configured to acquire a first instruction and, transmit the first instruction and a first operand to the processing unit in response to acquiring the first operand of the first instruction, and the first-stage pipelining is any one stage of pipelining in the multi-stage pipelining; and the processing unit is configured to acquire a first processing result by receiving and processing the first instruction and the first operand.

In some embodiments, the first-stage pipelining is further configured to, in response to acquiring the first operand, send a first contention request to the processing unit, and acquire a contention result for the processing unit, and the contention result indicates whether the processing unit is capable of processing the first instruction and the first operand; and the first-stage pipelining is configured to, in a case that the contention result is a successful contention, transmit the first instruction and the first operand to the processing unit.

In some embodiments, the processing unit is further configured to determine the contention result based on the first contention request, a second contention request, a priority of the first-stage pipelining, and a priority of a second-stage pipelining in the multi-stage pipelining, and transmit the contention result to the first-stage pipelining, where the second contention request is transmitted to the processing unit in a case that the second-stage pipelining acquires a second operand.

In some embodiments, the priority of the first-stage pipelining and the priority of the second-stage pipelining are determined based on a sequence in which the first-stage pipelining and the second-stage pipelining acquire the instructions.

In some embodiments, the processing apparatus further includes a result module, the result module is connected to the processing unit, and the result module is configured to store and transmit processing results corresponding to the instructions of the multi-stage pipelining; and the result module is configured to receive a second processing result from the processing unit, and transmit the first operand to the first-stage pipelining in a case that the second processing result includes the first operand, where the second processing result is acquired based on a third instruction and a third operand transmitted by a third-stage pipelining in the multi-stage pipelining.

In some embodiments, the processing apparatus further includes an issue module and a register module, and the issue module is respectively connected to the register module and the multi-stage pipelining; the issue module is configured to read the first operand from the register module and transmit the first operand to the first-stage pipelining; and the first-stage pipelining is further configured to receive the first operand.

In some embodiments, the issue module is further configured to transmit the first instruction to the first-stage pipelining; and the first-stage pipelining is configured to receive the first instruction.

In some embodiments, the first-stage pipelining is connected to a fourth-stage pipelining, and the fourth-stage pipelining acquires the first instruction before the first-stage pipelining; the fourth-stage pipelining is configured to transmit the first instruction to the first-stage pipelining; and the first-stage pipelining is configured to receive the first instruction.

Some embodiments of the present disclosure provide a method for processing instructions. The method is applicable to a processing apparatus. The processing apparatus includes a processing unit and a multi-stage pipelining. The processing unit is configured to execute instructions corresponding to the multi-stage pipelining. The method includes: acquiring, by a first-stage pipelining in the multi-stage pipelining, a first instruction and, transmitting the first instruction and a first operand to the processing unit in response to acquiring the first operand of the first instruction, where the first-stage pipelining is any one stage of pipelining in the multi-stage pipelining; and acquiring a first processing result by receiving and processing, by the processing unit, the first instruction and the first operand.

In some embodiments, transmitting the first instruction and the first operand to the processing unit in response to acquiring the first operand of the first instruction includes: sending, by the first-stage pipelining, a first contention request to the processing unit in response to acquiring the first operand; acquiring, by the first-stage pipelining, a contention result for the processing unit, where the contention result indicates whether the processing unit is capable of processing the first instruction and the first operand; and transmitting, by the first-stage pipelining, the first instruction and the first operand to the processing unit in a case that the contention result is a successful contention.

In some embodiments, before acquiring, by the first-stage pipelining, the contention result for the processing unit, the method further includes: determining, by the processing unit, the contention result based on the first contention request, a second contention request, a priority of the first-stage pipelining, and a priority of a second-stage pipelining in the multi-stage pipelining, and transmitting the contention result to the first-stage pipelining, where the second contention request is transmitted to the processing unit in a case that the second-stage pipelining acquires a second operand.

In some embodiments, the priority of the first-stage pipelining and the priority of the second-stage pipelining are determined based on a sequence in which the first-stage pipelining and the second-stage pipelining acquire the instructions.

In some embodiments, the processing apparatus further includes a result module, the result module is connected to the processing unit, and the result module is configured to store and transmit processing results corresponding to the instructions of the multi-stage pipelining; and before transmitting the first instruction and the first operand to the processing unit in response to acquiring the first operand of the first instruction, the method further includes: receiving, by the result module, a second processing result from the processing unit, and transmitting the first operand to the first-stage pipelining in a case that the second processing result includes the first operand, where the second processing result is acquired based on a third instruction and a third operand transmitted by a third-stage pipelining in the multi-stage pipelining.

In some embodiments, the processing apparatus further includes an issue module and a register module, and the issue module is respectively connected to the register module and the multi-stage pipelining; and before transmitting the first instruction and the first operand to the processing unit in response to acquiring the first operand of the first instruction, the method further includes: reading, by the issue module, the first operand from the register module and transmitting the first operand to the first-stage pipelining; and receiving, by the first-stage pipelining, the first operand.

In some embodiments, acquiring the first instruction includes: transmitting, by the issue module, the first instruction to the first-stage pipelining; and receiving, by the first-stage pipelining, the first instruction.

In some embodiments, the first-stage pipelining is connected to a fourth-stage pipelining, and the fourth-stage pipelining acquires the first instruction before the first-stage pipelining; acquiring the first instruction includes: transmitting, by the fourth-stage pipelining, the first instruction to the first-stage pipelining; and receiving, by the first-stage pipelining, the first instruction.

Some embodiments of the present disclosure provide an electronic device. The electronic device includes a processing apparatus and a memory, the memory stores at least one instruction, and the at least one instruction, when loaded and executed by the processing apparatus, causes the electronic device to perform the method for processing instructions above.

### BRIEF DESCRIPTION OF THE DRAWINGS

FIG. 1 is a schematic structural diagram of a pipeline-type processing apparatus according to the related art;

FIG. 2 is a schematic structural diagram of a processing apparatus according to some embodiments of the present disclosure;

FIG. 3 is a schematic structural diagram of another processing apparatus according to some embodiments of the present disclosure;

FIG. 4 is a flowchart of a method for processing instructions according to some embodiments of the present disclosure; and

FIG. 5 is a schematic structural diagram of an electronic device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The process of processing instructions by the processing apparatus includes stages of acquiring, decoding, executing, memory, writing back or the like, and in one cycle, one unit in the processing apparatus executes an operation corresponding to one stage. For example, in one cycle, one unit performs the acquire operation corresponding to instruction a. In a conventional processing apparatus, one unit performs operations in one cycle, and operations corresponding to a plurality of stages of one instruction are completed by one unit in a plurality of cycles. The other units wait for the unit to complete all operations of the instruction before processing other instructions.

With the development of electronic technologies, more and more instructions need to be processed by the processing apparatus, and the efficiency of processing instructions by the conventional processing apparatus is low, so the instructions needing to be processed are difficult to process in time. In this case, a pipeline-type processing apparatus is produced.

In the pipeline-type processing apparatus, different processing stages of an instruction are executed by different units, respectively. After completing the processing of the unit, each unit transfers (pipes) the processed instruction to an adjacent unit, such that the plurality of units cooperate to complete the processing of each instruction.

Moreover, in the pipeline-type processing apparatus, the units simultaneously perform operations without waiting. For example, in cycle 1, unit 1 performs the acquire operation of instruction a and transfers instruction a to unit 2 after completing the operation. In cycle 2, unit 1 performs the acquire operation of instruction b while unit 2 performs the decode operation of instruction a, unit 1 transfers instruction b to unit 2 after completing the operation, and unit 2 transfers instruction a to unit 3 after completing the operation. In cycle 3, unit 1 performs the acquire operation of instruction c while unit 2 performs the decode operation of instruction b and unit 3 performs the operation of instruction a, unit 1 transfers instruction c to unit 2 after completing the operation, unit 2 transfers instruction b to unit 3 after completing the operation, and unit 3 transfers instruction a to unit 4 after completing the operation. By analogy, each unit in the pipeline-type processing apparatus processes different instructions in one cycle, and a plurality of instructions are processed in parallel in one cycle, such that the efficiency of the processing apparatus for processing the instructions is improved.

In an in-order processing apparatus, in the case that the processing apparatus is implemented as a pipeline-type micro-architecture, instructions are transmitted to the units in a storage order of the instructions. For example, an issue module in the processing apparatus reads an instruction and an operand required by the instruction in a register module in an issue stage, and issues the instruction and the operand required by the instruction into a pipelining section (also referred to as a pipelining stage).

In addition, after the processing of each stage of the instruction is completed, a processing result is transmitted to a result module in the processing apparatus.

In some cases, the operand required for instruction 0 comes from instruction 1 being executed, and the result module in the processing apparatus transmits the operand required for instruction 0 to the issue module over a forward network after receiving a processing result of instruction 1 being executed. In the case that the issue module does not acquire the operand required for instruction 0, instruction 0 stalls in the issue module.

With the development of the pipeline-type processing apparatus, even if the issue module does not acquire the operands corresponding to the instructions in the case that part of the instructions are issued, the processing apparatus can issue the instructions with operands unprepared in advance, such that the instructions in the in-order processing apparatus are slightly out-of-order.

For these instructions issued in advance, the operands are typically acquired over the forward network and then are processed in the corresponding units. For example, a large number of arithmetic and logical operation instructions exist in an instruction stream processed by the processing apparatus, and these operations are implemented by an arithmetic logic unit (ALU). A result of the ALU operation may be fed forward to a unit where the subsequent instructions are located over the forward network, such that the unit where the subsequent instructions are located acquires the required operands. Therefore, the ALU operation is accelerated, such that the performance of the processing apparatus can be improved.

In the related art, arithmetic and logical operation instructions issued in advance are transferred to a fixed ALU in a pipeline for processing after operands are obtained, resulting in operation results are not obtained in time in corresponding units of the pipeline, and the reuse rate of the ALU is low.

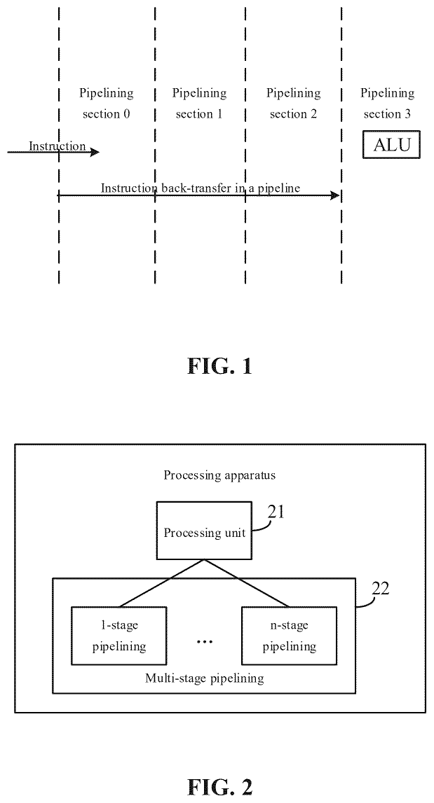

For example, refer to a schematic diagram of a partial structure of a pipeline-type processing apparatus shown in FIG. 1. The pipeline-type processing apparatus includes pipelining sections 0 to 3, each pipelining section configured to process instructions at different stages. In the processing apparatus, an ALU is disposed in the pipelining section 3, and the ALU can be called only by the pipelining section 3.

In this case, in the case that an operand corresponding to the instruction is acquired when an arithmetic and logic operation instruction issued in advance is operated at the pipelining section 1, since the pipelining section 1 cannot call the ALU, the pipelining section 1 cannot operate the operand according to the instruction, and cannot complete processing of the instruction and the operand.

The pipelining section 1 can only transmit the instruction and the operand to the following pipelining section 2, but the pipelining section 2 cannot call the ALU, so the pipelining section 2 can also not complete the processing of the instruction and the operand, and the pipelining section 2 can only transmit the instruction and the operand corresponding to the instruction to the following pipelining section 3.

Since the pipelining section 3 can call the ALU, the pipelining section 3 performs an operation on the operand according to the instruction by calling the ALU, and completes the processing of the instruction and the operand. Therefore, in the process from the stage of acquiring the operand by the pipelining section to the stage of completing the processing of the instruction and the operand by the pipelining section, there are two cycles in which the instruction and the operand are not processed, and therefore, the instruction is operated by the fixed ALU, resulting in low overall processing efficiency of the instruction.

Therefore, the number and position of ALUs in the processing apparatus have a great influence on the performance of the processing apparatus for processing instructions, and the earlier the ALU operation is performed, the earlier the ALU result is obtained, and thus the stall of the instruction that depends on the ALU instruction result at the issue stage is released.

Embodiments of the present disclosure provide a processing apparatus, which can improve the overall processing efficiency of instructions. Referring to FIG. 2, a schematic structural diagram of a processing apparatus according to some embodiments of the present disclosure is shown. The processing apparatus is a pipeline-type (or execution pipeline-type) processing apparatus, such as a pipeline-type central processing unit (CPU). The processing apparatus includes a processing unit 21 and a multi-stage pipelining 22 in the pipeline, and the multi-stage pipelining is a sequence of stages in the processing apparatus. Each layer in the sequence of stages may also be referred to as each pipe or each stage of pipelining, one stage of pipelining includes a register section and a hardware circuit connected to the register section, and the hardware circuit is configured to be connected to adjacent pipelinings, transmit data between adjacent pipelinings, perform logic determination, or the like, for example, the hardware circuit determines whether a transmitted instruction is valid.

Since one stage of pipelining is a module or a unit for executing instructions, the one stage of pipelining may also be referred to as an execute (ex) unit or an execute module, and each stage of pipelining has capabilities of data transmission, buffering, logic determination, or the like. In the embodiments of the present disclosure, the operation executed by any stage of pipelining is executed by one register section and the hardware circuit in any stage of pipelining separately or together.

The processing unit 21 is configured to execute instructions of the multi-stage pipelining 22, and is implemented in that the processing unit 21 is directly connected to the multi-stage pipelining 22, that is, one processing unit 21 is connected to the hardware circuit of the multi-stage pipelining 22, such that the multi-stage pipelining 22 performs data transmission with one processing unit 21. The processing unit 21 is an ALU or other unit capable of performing arithmetic processing on the instructions. In some embodiments, the processing apparatus includes one or more processing units 21, and each processing unit 21 is configured to execute the instructions of the multi-stage pipelining 22. In the embodiments of the present disclosure, a first-stage pipelining, a second-stage pipelining, or the like in the multi-stage pipelining are used to distinguish different stages of pipelining in the multi-stage pipelining, and the terms “first”, “second”, or the like are used to distinguish different stages of pipelining. It should be understood that a processor pipelining may have other pipelining (sections) before the first-stage pipelining.

Hereinafter, the composition and function of each part of the processing apparatus are exemplarily described.

The first-stage pipelining in the multi-stage pipelining is configured to acquire a first instruction and, in the case that a first operand of the first instruction is acquired, transmit the first instruction and the first operand to the processing unit.

The processing unit is configured to receive the first instruction and the first operand, and process the first instruction and the first operand to acquire a first processing result.

The first-stage pipelining is any one stage of pipelining in the multi-stage pipelining, for example, the first-stage pipelining is 1-stage pipelining, 2-stage pipelining or n-stage pipelining in FIG. 2.

Since the first instruction may be an instruction that is sequentially issued or an instruction whose operand is not prepared and issued in advance, in the case that the first-stage pipelining acquires the first instruction, the corresponding first operand may not be acquired, and the first instruction and the first operand may not be transmitted to the processing unit simultaneously. In the case that the first-stage pipelining acquires the first operand, the first instruction and the first operand may be transmitted to the processing unit connected to the first-stage pipelining, such that the processing unit can process the first instruction and the first operand.

The embodiments of the present disclosure do not limit the manner in which the first-stage pipelining acquires the first instruction. Exemplarily, since the processing apparatus is a pipeline-type processing apparatus, the first-stage pipelining is connected to other stages of pipelining and receives the first instruction transmitted by other stages of pipelining. Taking the example that first-stage pipelining is connected to a fourth-stage pipelining, the fourth-stage pipelining transmits the first instruction to the first-stage pipelining; and the first-stage pipelining receives the first instruction. The fourth-stage pipelining acquires the first instruction before the first-stage pipelining.

The fourth-stage pipelining is, for example, 1-stage pipelining in FIG. 2, and the first-stage pipelining is, for example, 2-stage pipelining in FIG. 2.

In the case that the fourth-stage pipelining acquires the first instruction but does not acquire the first operand, the fourth-stage pipelining cannot call the processing unit connected to the fourth-stage pipelining to process the first instruction, such that the fourth-stage pipelining transmits the first instruction backward to the first-stage pipelining, and the first-stage pipelining receives the first instruction to acquire the first instruction.

In some embodiments, the processing apparatus further includes an issue module, and the issue module is connected to the first-stage pipelining. For example, in the case that the first-stage pipelining is 1-stage pipelining in the multi-stage pipelining, the first-stage pipelining is connected to the issue module. Therefore, the issue module transmits the first instruction to the first-stage pipelining after acquiring the first instruction; and the first-stage pipelining can acquire the first instruction by receiving the first instruction.

The manner in which the issue module acquires the first instruction is not limited by the embodiments of the present disclosure. Exemplarily, the processing apparatus further includes a register module. The register module is a general purpose register (GPR), and stores instructions to be processed by the processing apparatus. Therefore, the issue module reads the first instruction from the register module so as to acquire the first instruction.

Accordingly, the embodiments of the present disclosure also do not limit the manner in which the first-stage pipelining acquires the first operand. Based on the foregoing, the processing apparatus further includes the issue module and the register module. The register module can store not only each instruction to be processed by the processing apparatus, but also operands required by part of the instructions and information such as storage addresses of the operands. Therefore, in the case that the register module stores the first operand, the issue module reads the first operand from the register module and transmits the first operand to the first-stage pipelining; and the first-stage pipelining acquires the first operand by receiving the first operand.

In some embodiments, the processing apparatus further includes a result module, and the result module is connected to the processing unit. The result module, which may also be referred to as a result register module, is configured to store and transmit execution results of the instructions of the multi-stage pipelining. Since the processing result of one instruction may be an operand required by another instruction, the result module can feed forward the processing result of one instruction to the pipelining in which the other instruction is located, such that the pipelining in which the other instruction is located acquires the required operand and calls the processing unit to process the other instruction and the operand corresponding to the other instruction.

Exemplarily, the result module receives a second processing result transmitted by the processing unit, and in the case that the second processing result includes the first operand, transmits the first operand to the first-stage pipelining. The second processing result is obtained based on a third instruction and a third operand transmitted by a third-stage pipelining in the multi-stage pipelining. The third-stage pipelining is a pipelining adjacent to the first-stage pipelining or is a pipelining not adjacent to the first-stage pipelining.

After the first instruction and the first operand are acquired, the first-stage pipelining transmits the first instruction and the first operand to the processing unit, such that the processing unit can process the first instruction and the first operand to obtain the first processing result.

However, since the processing unit is directly connected to the multi-stage pipelining, the processing unit is called by the multi-stage pipelining. Moreover, in one cycle, only one instruction and the corresponding operand sent by the first-stage pipelining are processed by one processing unit. Therefore, in the case that the multi-stage pipelining connected to one processing unit acquires the operand required by each stage in the same cycle, the multi-stage pipelining sends a contention request to the processing unit to perform contention on the processing unit, and whether each stage of pipelining calls the processing unit in the cycle is determined based on the contention result.

That is, the processing unit can only process the instruction and the operand sent by one stage of pipelining in the cycle. Therefore, the first instruction and the first operand may not necessarily be able to be processed by the processing unit immediately after the first-stage pipelining sends the first instruction and the first operand to the processing unit.

In the case that the multi-stage pipelining connected to one processing unit acquires the respective required operands in the same cycle and the processing unit receives the instructions and operands sent by the multi-stage pipelining, the processing unit determines an instruction and an operand sent by which stage of pipelining to be processed in the current cycle.

For example, in the case that the first-stage pipelining acquires the first operand, the first-stage pipelining sends a first contention request to the processing unit, and acquires a contention result for the processing unit. The contention result indicates whether the processing unit is capable of processing the first instruction and the first operand.

The embodiments of the present disclosure do not limit the manner in which the first-stage pipelining acquires the contention result. For example, the contention result is determined and sent by the processing unit contending by the first-stage pipelining and other stages of pipelining. Therefore, before the first-stage pipelining acquires the contention result, the processing unit determines the contention result according to the first contention request, a second contention request, a priority of the first-stage pipelining, and a priority of the second-stage pipelining. The second-stage pipelining is a pipelining except the first-stage pipelining in the multi-stage pipelining, and the second contention request is transmitted to the processing unit in the case that the second-stage pipelining acquires a second operand.

In some embodiments, the priority of the first-stage pipelining and the priority of the second-stage pipelining are determined based on a sequence in which the first-stage pipelining and the second-stage pipelining acquire instructions. The reason is that the earlier the sequence in which instructions are acquired by any one stage of pipelining, the longer the execution time of the instructions, and the more the instruction should be processed preferentially, such that the execution time of the instructions is shortened, thereby improving the instruction execution efficiency of the processor. In addition, the earlier the sequence in which the instructions are acquired by any one stage of pipelining, the more the subsequent instructions depending on the processing result of the instruction acquired by this stage of pipelining, such that the instruction and operand acquired earlier are processed preferentially, the dependence on other instructions is removed more quickly, and the processing of the subsequent instructions is accelerated.

In some embodiments, the sequence in which the first-stage pipelining and the second-stage pipelining acquire the instructions may be determined based on an instruction transfer sequence of the first-stage pipelining and the second-stage pipelining in the multi-stage pipelining. For example, in FIG. 2, the instruction transfer sequence is from the 1-stage pipelining to the n-stage pipelining, and then the sequence in which the 1-stage pipelining acquires the instructions is later than the sequence in which other stages of pipelining acquire the instructions, that is, in the same cycle, the instructions acquired by the other stages of pipelining are all issued before the instructions acquired by the 1-stage pipelining, such that the later the instruction transfer sequence of the pipelining, the earlier the sequence in which the pipelining acquires the instructions.

Therefore, in the case that the time for the first-stage pipelining to acquire the first instruction is earlier than the time for the second-stage pipelining to acquire a second instruction, the processing unit determines that the first-stage pipelining can call the processing unit in this cycle, a contention result corresponding to the first-stage pipelining is a successful contention, and a contention result corresponding to the second-stage pipelining is a failed contention.

In some embodiments, the determination of the contention result by the processing unit is achieved by adding a multiplexer (mux) circuit in the processing unit.

For example, the mux includes a plurality of input ports, each port is configured to transmit an input signal to the mux, the mux further has a port for receiving a selection signal, and the selection signal indicates the mux to select which input signal to output. The plurality of input signals are contention requests sent by the multi-stage pipelining to the processing unit, and the selection signal is a signal determined based on the priority of the multi-stage pipelining.

For example, the first contention request sent by the first-stage pipelining to the processing unit is one input signal of the mux in the processing unit, and the second contention request sent by the second-stage pipelining to the processing unit is another input signal of the mux in the processing unit. The selection signal is a signal determined based on the priority of the first-stage pipelining and the priority of the second-stage pipelining. In the case that the selection signal indicates that the priority of the first-stage pipelining is higher, the mux selects the first contention request sent by the first-stage pipelining to output, which represents that the contention result corresponding to the first-stage pipelining is a successful contention and the contention result corresponding to the second-stage pipelining is a failed contention. In the case that the selection signal indicates that the priority of the second-stage pipelining is higher, the mux selects the second contention request sent by the second-stage pipelining to output, which represents that the contention result corresponding to the first-stage pipelining is a failed contention and the contention result corresponding to the second-stage pipelining is a successful contention.

Further, the selection signal is a digital signal in binary representation. The value of the digital signal is used for controlling whether different input ports and output ports are conducted or not, such that the output port of the mux is controlled to output an input signal corresponding to the input port, and a signal output by the output port is a signal selected by the mux. Taking the example that the mux includes two input ports, in the case that the value of the selection signal is 01, the first input port and the output port are conducted, and the output port outputs the signal input through the first input port. In the case that the value of the selection signal is 10, the second input port and the output port are conducted, and the output port outputs the signal input via the second input port.

For example, in the case that the first contention request is input to the mux via the first port, the second contention request is input to the mux via the second port. The selection signal is 01 in the case that the priority of the first-stage pipelining is higher than the priority of the second-stage pipelining. The selection signal is 10 in the case that the priority of the second-stage pipelining is higher than the priority of the first-stage pipelining.

In some embodiments, the contention request of each stage of pipelining is an instruction and an operand acquired by the stage of pipelining. For example, the first contention request is a first instruction and a first operand acquired by the first-stage pipelining. In these embodiments, the contention request output by the mux is transmitted to a portion of the processing unit that is configured to process instructions and operands, such as a comparator, an adder, or a subtractor, such that the processing unit may perform the instruction and operand processing as soon as possible after determining the contention result.

After determining the contention result, the processing unit transmits the contention result to the first-stage pipelining and the second-stage pipelining, such that the first-stage pipelining and the second-stage pipelining determines whether to contend for the processing unit, thereby determining whether to send the processing instruction and the operand to the processing unit.

In the case that the first contention request sent by the first-stage pipelining includes the first instruction and the first operand and the second contention request sent by the second-stage pipelining includes the second instruction and the second operand, after the contention result is determined, the pipelining which contends successfully does not need to repeatedly send the processing instruction and the operand to the processing unit, and the consumption of resources is reduced.

In some embodiments, each stage of pipelining sends the contention request to other stages of pipelining connected to the processing unit after receiving the required operand. Each stage of pipelining autonomously determines the contention result of each stage of pipelining based on the received contention request and the priority of each stage of pipelining acquiring the operand, and determines whether to transmit the instruction and the operand to the processing unit based on the respective contention result.

Exemplarily, the first-stage pipelining sends the first contention request to a fifth-stage pipelining in the case that the first operand is acquired. The fifth-stage pipelining and the first-stage pipelining are connected to the same processing unit, and one or more fifth-stage pipelinings may be provided.

Taking the example that a plurality of fifth-stage pipelinings are provided, the first-stage pipelining further receives a third contention request sent by the fifth-stage pipelining which acquires the operand in the fifth-stage pipelinings. The first-stage pipelining determines the first contention result according to the priority of the first-stage pipelining and the priority of the fifth-stage pipelining which acquires the operand. In the case that the priority of the first-stage pipelining is higher than that of the fifth-stage pipelining, the first contention result is a successful contention, and the first-stage pipelining transmits the first instruction and the first operand to the processing unit. In the case that the priority of the first-stage pipelining is lower than that of the fifth-stage pipelining, the first contention result is a failed contention, and the first-stage pipelining temporarily does not transmit the first instruction and the first operand to the processing unit.

In addition, any fifth-stage pipelining that acquires the operand may also receive the first contention request transmitted by the first-stage pipelining and the third contention request transmitted by other fifth-stage pipelining that acquires the operand, such that any fifth-stage pipelining that acquires the operand can also determine a contention result of any fifth-stage pipelining that acquires the operand according to the priority of the first-stage pipelining and the priority of each fifth-stage pipelining which acquires the operand.

In the case that the contention result of any fifth-stage pipelining that acquires the operand is a successful contention, the acquired instruction and operand are sent to the processing unit. In the case that the contention result is a failed contention, the acquired instruction and operand are temporarily not sent to the processing unit.

In the case that the contention result of the first-stage pipelining is a successful contention, the first-stage pipelining transmits the contention result to the processing unit while transmitting the first instruction and the first operand to the processing unit, such that the processing unit determines to process the first instruction and the first operand. In the case that the contention result of any fifth-stage pipelining that acquires the operand is a failed contention, the instruction and the operand are transmitted to the processing unit, and the processing unit cannot process the instruction and the operand, thereby ensuring the accuracy of the processing sequence and the processing result.

No matter what way the first-stage pipelining acquires the contention result, the first-stage pipelining transmits the first instruction and the first operand to the processing unit in the case that the contention result acquired by the first-stage pipelining is a successful contention. Then, the processing unit receives the first instruction and the first operand and processes the first instruction and the first operand to obtain a first processing result.

The process of determining the contention result is a process in one cycle, and for the pipelining of which the contention result in the cycle is a failed contention, the acquired instruction and operand may be transmitted to the next stage of pipelining after the cycle is finished. In the next cycle, the next stage of pipelining sends the contention request to the processing unit again. By analogy, the above process is performed until any instruction and corresponding operand are processed by the processing unit.

Taking the example that the processing unit is an ALU unit and the first instruction is an operation instruction, after receiving the first instruction and the first operand, the processing unit performs an operation on the first operand based on the first instruction, and an operation result is the processing result. For example, the first instruction is an addition instruction and the first operand includes operand a and operand b, so the processing unit adds operand a and operand b, and the resulting sum is the first processing result.

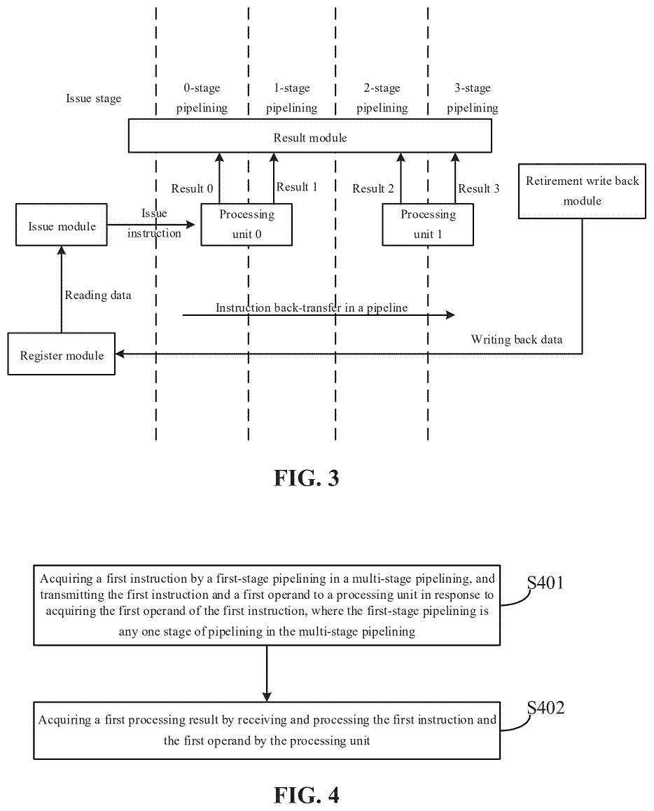

Hereinafter, with reference to FIG. 3, the functions of each part of the processing apparatus provided in the embodiments of the present disclosure are described by way of a complete example. The processing apparatus is a pipeline-type processing apparatus, and instructions are transmitted backwards in a pipeline through various stages of pipelining.

The processing apparatus includes a multi-stage pipelining, an issue module, a register module, a result module, a processing unit 0, a processing unit 1 and a retirement write back module. The processing unit 0 is configured to process instructions and operands for a 0-stage pipelining and a 1-stage pipelining, and the processing unit 1 is configured to process instructions and operands for a 2-stage pipelining and a 3-stage pipelining.

The issue module reads data such as the instructions and the operands from the register module and issues the instructions to each stage of pipelining in the pipeline at the issue stage. In the 0-stage pipelining to the 3-stage pipelining, judgment logics for judging whether to acquire the operands and judgment logics for judging whether to contend for the processing units are added. In the case that any one stage of pipelining acquires the operand, contention for the processing unit connected to the stage of pipelining is performed, and whether any one stage of pipelining contends for the processing unit is judged.

For example, in the case that the 0-stage pipelining and the 1-stage pipelining simultaneously acquire the operands, the processing unit 0 processes the instruction and the operand transmitted by the 1-stage pipelining since the 1-stage pipelining has a higher priority than the 0-stage pipelining. In the case that only one (for example, the 0-stage pipelining or the 1-stage pipelining) of the 0-stage pipelining and the 1-stage pipelining acquires the operand, the contention does not exist, and the stage of pipelining that acquires the operand directly calls the processing unit to process the instruction and the operand. In the case that the 2-stage pipelining and the 3-stage pipelining acquire the operands simultaneously, the instructions and the operands are processed in a similar manner, which is not described herein again.

In addition, in the case that the processing of the instruction is completed, the processing unit transmits the processing result to the result module, the result module sends the processing result to the retirement write back module, and the processing unit may also send the processed instruction to the retirement write back module. The retirement write back module may also be referred to as a retirement write back unit (rtu), perform retirement processing on the processed instruction and writes back the processing result and other data to the register module.

The processing apparatus shown in FIG. 3 implements processing of instructions and operands acquired by four stages of pipelining from the 0-stage pipelining to the 3-stage pipelining by using two processing units. The processing apparatus improves the reuse rate of the processing units by dynamically adjusting the calling relationship between the processing units and each stage of pipelining connected thereto, and obtains the processing result in time, thereby forwarding the processing result through a forward network, and improving the performance of the processing apparatus for processing the instructions.

In some related arts, the arithmetic efficiency of the processing apparatus for instructions is improved by increasing the number of ALUs, thereby improving the efficiency of the processing apparatus for processing the instructions. For example, each stage of pipelining is individually directly connected to one processing unit, such that a ratio of the pipelinings to the processing units is 1:1. However, this method increases the volume and power consumption of the processing apparatus. The processing apparatus provided by the embodiments of the present disclosure improves the processing efficiency of the instructions and simultaneously avoids excessively increasing the volume and power consumption of the processing apparatus, such that the processing apparatus is balanced among high efficiency, low power consumption and small volume.

In summary, in the processing apparatus provided in the embodiments of the present disclosure, one processing unit can be responsible for executing the instructions of the multi-stage pipelining, thereby improving the reuse rate of the processing unit and improving the efficiency of the processing apparatus for processing the instructions.

In some exemplary embodiments, the embodiments of the present disclosure further provide a method for processing instructions, applicable to the processing apparatus described above. Referring to FIG. 4, a flowchart of a method for processing instructions is shown. The method includes, but is not limited to, S401 and S402 as follows.

In S401, a first instruction is acquired by a first-stage pipelining in a multi-stage pipelining, and the first instruction and a first operand are transmitted to a processing unit in response to acquiring the first operand of the first instruction, where the first-stage pipelining is any one stage of pipelining in the multi-stage pipelining.

In S402, the first instruction and the first operand are received by the processing unit, and are processed to obtain a first processing result.

In some embodiments, before transmitting the first instruction and the first operand to the processing unit in response to acquiring the first operand of the first instruction, the method further includes: sending, by the first-stage pipelining, a first contention request to the processing unit in response to acquiring the first operand; acquiring, by the first-stage pipelining, a contention result for the processing unit, where the contention result indicates whether the processing unit is capable of processing the first instruction and the first operand; and transmitting, by the first-stage pipelining, the first instruction and the first operand to the processing unit in a case that the contention result is a successful contention.

In some embodiments, before acquiring, by the first-stage pipelining, the contention result for the processing unit, the method further includes: determining, by the processing unit, the contention result based on the first contention request, a second contention request, a priority of the first-stage pipelining, and a priority of a second-stage pipelining in the multi-stage pipelining, and transmitting the contention result to the first-stage pipelining, where the second contention request is transmitted to the processing unit in a case that the second-stage pipelining acquires a second operand.

In some embodiments, the priority of the first-stage pipelining and the priority of the second-stage pipelining are determined based on a sequence in which the first-stage pipelining and the second-stage pipelining acquire the instructions.

In some embodiments, the processing apparatus further includes a result module connected to the processing unit, and the result module is configured to store and transmit processing results corresponding to the instructions of the multi-stage pipelining; and before transmitting the first instruction and the first operand to the processing unit in response to acquiring the first operand of the first instruction, the method further includes: receiving, by the result module, a second processing result transmitted by the processing unit, and transmitting the first operand to the first-stage pipelining in a case that the second processing result includes the first operand, where the second processing result is acquired based on a third instruction and a third operand transmitted by a third-stage pipelining in the multi-stage pipelining.

In some embodiments, the processing apparatus further includes an issue module and a register module, and the issue module is respectively connected to the register module and the multi-stage pipelining; and before transmitting the first instruction and the first operand to the processing unit in response to acquiring the first operand of the first instruction, the method further includes: reading, by the issue module, the first operand from the register module and transmitting the first operand to the first-stage pipelining; and receiving, by the first-stage pipelining, the first operand.

In some embodiments, acquiring the first instruction includes: transmitting, by the issue module, the first instruction to the first-stage pipelining; and receiving, by the first-stage pipelining, the first instruction.

In some embodiments, the first-stage pipelining is connected to a fourth-stage pipelining, and the fourth-stage pipelining acquires the first instruction before the first-stage pipelining; acquiring the first instruction includes: transmitting, by the fourth-stage pipelining, the first instruction to the first-stage pipelining; and receiving, by the first-stage pipelining, the first instruction.

The method for processing instructions provided in the embodiments of the present disclosure is executed by the processing apparatus described above, and the description and the beneficial effects of the processing apparatus executing the method may refer to the description and the beneficial effects of the processing apparatus described above, which are not described herein again.

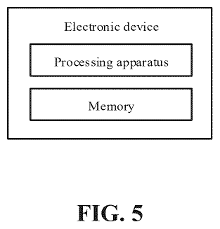

In some exemplary embodiments, the embodiments of the present disclosure further provide an electronic device. As shown in FIG. 5, the electronic device includes a processing apparatus and a memory. The memory stores at least one instruction, and the processing apparatus may be the processing apparatus in the above embodiments. At least one instruction is loaded and executed by the processing apparatus, such that the electronic device implements any method for processing the instructions described above.

It should be noted that the information (including, but not limited to, user device information, user personal information, etc.), data (including, but not limited to, data for analysis, stored data, displayed data, etc.) and signals, which are referred to in the present disclosure, are authorized by the user or fully authorized by various parties, and the collection, use and processing of the relevant data are required to comply with relevant laws and regulations and standards in relevant countries and regions. For example, the instructions and the operands involved in the present disclosure are acquired with sufficient authority.

It should be understood that the term “a plurality of” herein means two or more. The term “and/or” describes the association relationship between the associated objects, and indicates that three relationships may be present. For example, A and/or B may indicate that: only A is present, both A and B are present, and only B is present. The symbol “/” generally indicates an “or” relationship between the associated objects.

It should be noted that the terms “first”, “second”, or the like in the specification and claims of the present disclosure are configured to distinguish similar objects, and do not have to be used to describe a specific order or sequence. It should be understood that the data so used is interchangeable under appropriate circumstances such that the embodiments of the present disclosure described herein are capable of implementation in other sequences than those illustrated or described herein. The embodiments described in the following exemplary embodiments do not represent all embodiments consistent with the present disclosure. Rather, they are merely examples of apparatus and methods consistent with certain aspects of the present disclosure, as detailed in the appended claims.

Described above are merely exemplary embodiments of the present disclosure and are not intended to limit the present disclosure. Any modifications, equivalents, improvements, or the like, made within the principle of the present disclosure should fall within the protection scope of the present disclosure.

1. A processing apparatus, comprising a processing unit and a multi-stage pipelining in a pipeline, wherein the processing unit is configured to execute instructions of the multi-stage pipelining;
a first-stage pipelining in the multi-stage pipelining is configured to acquire a first instruction and transmit the first instruction and a first operand to the processing unit in response to acquiring the first operand of the first instruction, and the first-stage pipelining is any one stage of pipelining in the multi-stage pipelining; and
the processing unit is configured to acquire a first processing result by receiving and processing the first instruction and the first operand.

2. The processing apparatus according to claim 1, wherein the first-stage pipelining is further configured to, in response to acquiring the first operand, send a first contention request to the processing unit, and acquire a contention result for the processing unit, and the contention result indicates whether the processing unit is capable of processing the first instruction and the first operand; and
the first-stage pipelining is configured to, in a case that the contention result is a successful contention, transmit the first instruction and the first operand to the processing unit.

3. The processing apparatus according to claim 2, wherein the processing unit is further configured to determine the contention result based on the first contention request, a second contention request, a priority of the first-stage pipelining, and a priority of a second-stage pipelining in the multi-stage pipelining, and transmit the contention result to the first-stage pipelining, and the second contention request is transmitted to the processing unit in a case that the second-stage pipelining acquires a second operand.

4. The processing apparatus according to claim 3, wherein the priority of the first-stage pipelining and the priority of the second-stage pipelining are determined based on a sequence in which the first-stage pipelining and the second-stage pipelining acquire the instructions.

5. The processing apparatus according to claim 1, further comprising a result module connected to the processing unit, wherein the result module is configured to store and transmit processing results corresponding to the instructions of the multi-stage pipelining; and
the result module is configured to receive a second processing result from the processing unit, and transmit the first operand to the first-stage pipelining in a case that the second processing result comprises the first operand, wherein the second processing result is acquired based on a third instruction and a third operand transmitted by a third-stage pipelining in the multi-stage pipelining.

6. The processing apparatus according to claim 2, further comprising a result module connected to the processing unit, wherein the result module is configured to store and transmit processing results corresponding to the instructions of the multi-stage pipelining; and
the result module is configured to receive a second processing result from the processing unit, and transmit the first operand to the first-stage pipelining in a case that the second processing result comprises the first operand, wherein the second processing result is acquired based on a third instruction and a third operand transmitted by a third-stage pipelining in the multi-stage pipelining.

7. The processing apparatus according to claim 3, further comprising a result module connected to the processing unit, wherein the result module is configured to store and transmit processing results corresponding to the instructions of the multi-stage pipelining; and
the result module is configured to receive a second processing result from the processing unit, and transmit the first operand to the first-stage pipelining in a case that the second processing result comprises the first operand, wherein the second processing result is acquired based on a third instruction and a third operand transmitted by a third-stage pipelining in the multi-stage pipelining.

8. The processing apparatus according to claim 4, further comprising a result module connected to the processing unit, wherein the result module is configured to store and transmit processing results corresponding to the instructions of the multi-stage pipelining; and
the result module is configured to receive a second processing result from the processing unit, and transmit the first operand to the first-stage pipelining in a case that the second processing result comprises the first operand, wherein the second processing result is acquired based on a third instruction and a third operand transmitted by a third-stage pipelining in the multi-stage pipelining.

9. The processing apparatus according to claim 1, further comprising an issue module and a register module, wherein the issue module is respectively connected to the register module and the multi-stage pipelining;
the issue module is configured to read the first operand from the register module and transmit the first operand to the first-stage pipelining; and
the first-stage pipelining is further configured to receive the first operand.

10. The processing apparatus according to claim 9, wherein the issue module is further configured to transmit the first instruction to the first-stage pipelining; and
the first-stage pipelining is configured to receive the first instruction.

11. The processing apparatus according to claim 1, wherein the first-stage pipelining is connected to a fourth-stage pipelining, and the fourth-stage pipelining acquires the first instruction before the first-stage pipelining;
the fourth-stage pipelining is configured to transmit the first instruction to the first-stage pipelining; and
the first-stage pipelining is configured to receive the first instruction.

12. A method for processing instructions, applicable to a processing apparatus, wherein the processing apparatus comprises a processing unit and a multi-stage pipelining in a pipeline, and the processing unit is configured to execute instructions of the multi-stage pipelining; and the method comprises:
acquiring a first instruction by a first-stage pipelining in the multi-stage pipelining, and transmitting the first instruction and a first operand to the processing unit in response to acquiring the first operand of the first instruction, wherein the first-stage pipelining is any one stage of pipelining in the multi-stage pipelining; and
acquiring a first processing result by receiving and processing the first instruction and the first operand by the processing unit.

13. The method according to claim 12, wherein transmitting the first instruction and the first operand to the processing unit in response to acquiring the first operand of the first instruction comprises:
sending, by the first-stage pipelining, a first contention request to the processing unit in response to acquiring the first operand;
acquiring, by the first-stage pipelining, a contention result for the processing unit, wherein the contention result indicates whether the processing unit is capable of processing the first instruction and the first operand; and
transmitting, by the first-stage pipelining, the first instruction and the first operand to the processing unit in a case that the contention result is a successful contention.

14. The method according to claim 13, wherein before acquiring, by the first-stage pipelining, the contention result for the processing unit, the method further comprises:
determining, by the processing unit, the contention result based on the first contention request, a second contention request, a priority of the first-stage pipelining, and a priority of a second-stage pipelining in the multi-stage pipelining, and transmitting the contention result to the first-stage pipelining, wherein the second contention request is transmitted to the processing unit in a case that the second-stage pipelining acquires a second operand.

15. The method according to claim 14, wherein the priority of the first-stage pipelining and the priority of the second-stage pipelining are determined based on a sequence in which the first-stage pipelining and the second-stage pipelining acquire the instructions.

16. The method according to claim 12, wherein the processing apparatus further comprises a result module connected to the processing unit, and the result module is configured to store and transmit processing results corresponding to the instructions of the multi-stage pipelining; and
before transmitting the first instruction and the first operand to the processing unit in response to acquiring the first operand of the first instruction, the method further comprises:
receiving, by the result module, a second processing result from the processing unit, and transmitting the first operand to the first-stage pipelining in a case that the second processing result comprises the first operand, wherein the second processing result is acquired based on a third instruction and a third operand transmitted by a third-stage pipelining in the multi-stage pipelining.

17. The method according to claim 12, wherein the processing apparatus further comprises an issue module and a register module, and the issue module is respectively connected to the register module and the multi-stage pipelining; and
before transmitting the first instruction and the first operand to the processing unit in response to acquiring the first operand of the first instruction, the method further comprises:
reading, by the issue module, the first operand from the register module and transmitting the first operand to the first-stage pipelining; and
receiving, by the first-stage pipelining, the first operand.

18. The method according to claim 17, wherein acquiring the first instruction comprises:
transmitting, by the issue module, the first instruction to the first-stage pipelining; and
receiving, by the first-stage pipelining, the first instruction.

19. The method according to claim 12, wherein the first-stage pipelining is coupled to a fourth-stage pipelining, and the fourth-stage pipelining acquires the first instruction before the first-stage pipelining;
acquiring the first instruction comprises:
transmitting, by the fourth-stage pipelining, the first instruction to the first-stage pipelining; and
receiving, by the first-stage pipelining, the first instruction.

20. An electronic device, comprising a processing apparatus and a memory, wherein the memory stores at least one instruction, and the at least one instruction, when loaded and executed by the processing apparatus, causes the electronic device to perform the method for processing instructions as defined in claim 12.
